(19) United States
(12) Patent Application Publication
(10) Pub. No.: US 2013/0226645 A1
(43) Pub. Date: Aug. 29, 2013

(54) METHOD AND APPARATUS FOR APPOINTMENT MATCHING AND SCHEDULING IN EVENT MANAGEMENT

(71) Applicant: CERTAIN, INC., (US)

(72) Inventor: Daniel RENAGHAN, Walnut Creek, CA (US)

(73) Assignee: CERTAIN, INC., SAN FRANCISCO, CA (US)

(21) Appl. No.: 13/774,907

(22) Filed: Feb. 22, 2013

Related U.S. Application Data
(60) Provisional application No. 61/603,197, filed on Feb. 24, 2012.

(51) Int. Cl. G06Q 10/10

(52) U.S. Cl. CPC G06Q 10/1095
USPC 705/7.19

(57) ABSTRACT

An appointment matching apparatus facilitates event management by performing a method for scheduling appointments among attendees of an event. An event organizer configures the apparatus with event-specific information. The apparatus generates registration and appointment preference user interface forms that attendees use to register for the event and to request appointments with other attendees. The appointment preference form may receive from an attendee criteria for identifying other attendees with whom there is a desire to meet. An appointment matching process automatically schedules a set of appointments between/among matched attendees to optimize fairness or effectiveness over the entire set of scheduled appointments. The appointment matching process uses configuration data for the event, registration information, appointment preference criteria, and meeting location information. Once all of the appointments have been scheduled, a unified calendar is provided to each attendee with the event schedule including all the automatically scheduled personal appointments.

### CROSS REFERENCE TO RELATED APPLICATIONS

This application claims the benefit of U.S. provisional patent application Ser. No. 61/603,197, filed Feb. 24, 2012, the entirety of which is incorporated herein by this reference thereto.

### BACKGROUND OF THE INVENTION

1. Field of the Invention

The invention relates to computer-assisted scheduling. More particularly, the invention concerns a matching and scheduling system that schedules meetings between individual attendees of an event or between an individual and a group of attendees.

2. Description of the Related Art

Event organizers are responsible for planning gatherings for a group of people. Events may include conferences, tradeshows, training sessions, retreats, user group meetings, etc. For attendees of these events, meeting and exchanging ideas with other people with common interests may be at least as important as the sessions that are scheduled as part of the event, such as lectures, demos, classes, panels, exhibits, birds-of-a-feature sessions, keynote addresses, and general meetings. To enable an attendee to maximize the return on their investment of time and money to attend an event, event organizers may schedule meetings between certain attendees with common interests in advance of the event. An example that is used throughout this document is an event that brings together people who have a product or service to sell (sellers) and other people who are in the market to buy a product or service (buyer). For some events, sellers may pay a fee to participate in the event, and the buyers may be invited to participate without paying a fee. Sometimes, a buyer travels with all expenses paid by the event organizer. Thus, an event organizer planning such an event may schedule appointments for a buyer to meet with one or more sellers or vice versa.

Scheduling a large number of meetings between individuals and groups involves at least two different tasks: 1) determining who should meet with whom and 2) determining when and where each appointment should occur. Existing approaches to automated scheduling only address the second task of determining when and where one appointment should be scheduled between two or more participants that have been identified as wanting or needing to meet. Online meeting and appointment schedulers take as input a list of participants to include in the same meeting and the calendar of each meeting participant and find a timeslot on the participants' calendars when all or a quorum are available to meet. Some of the calendaring tools allow participants to configure constraints into their calendars that will guide the tool in the selection of a satisfactory timeslot for that participant. Some examples of tools that identify a best timeslot given the input constraints include TimeBridge, Diarized, SAM, and Tungle. Other tools allow a meeting organizer to view meeting invitees' available timeslots to facilitate the manual selection of a timeslot that includes all or most of the invitees. Microsoft Outlook, Google Calendar, AgreeAdate, and Meeting Wizard are examples of such tools.

However, the online scheduling tools schedule an individual appointment in isolation, that is, each meeting is scheduled independent from any other meetings that also need to be scheduled. None of the online meeting and appointment scheduling tools addresses the need to determine which people from a potentially large pool of people should be meeting with each other, and attempt to optimize for fairness and/or effectiveness of scheduling of appointments across all of a potentially large number of appointments.

### SUMMARY OF THE INVENTION

An appointment scheduling device is a computer system that provides automated appointment scheduling among attendees at an event. An event organizer may configure the device to describe the attributes for a particular event. Some of the attributes provided in the configuration data may include a set of attendee types such as buyer, seller, exhibitor, speaker, student, executive . . . etc. Other attributes that may be configured are used to automatically generate custom user interface forms for each of one or more attendee types. The online forms are used by attendees to register for the event and to express meeting requests with appointment preferences. Based on the configuration data, a form is generated that is used as a registration interface. An attendee uses the registration interface to register for the event, and the registration data includes information about the attendee that may be used when setting up meetings with other attendees. Another form is generated that is used for expressing meeting requests and appointment preferences. Attendees may use this form to express characteristics of other attendees with whom they would like to meet.

Using the configuration data provided by the event organizer, the registration data describing attributes of each attendee, and appointment preference data describing attributes of other attendees, the appointment scheduling device schedules appointments among attendees, with each meeting appointment requested by one or both of the meeting participants, and the appointment is scheduled at a time and a location that is convenient for both/all participants in the meeting.

### BRIEF DESCRIPTION OF THE DRAWINGS

FIG. 1 is a simplified block diagram illustrating the components and use of an appointment management tool, according to an embodiment of the invention.

FIG. 2 illustrates an example schedule template according to an embodiment of the invention, according to an embodiment of the invention.

FIG. 3 is a screen shot showing a sample registration form for a buyer, according to an embodiment of the invention.

FIG. 4 shows an example screen shot of configuring an appointment preference form, according to an embodiment of the invention.

FIG. 5 is a screen shot illustrating another portion of the configuration process for configuring an appointment preference form, according to an embodiment of the invention.

FIG. 6 is a screen shot illustrating an appointment preference form, according to an embodiment of the invention.

FIG. 7 is a simplified flow diagram illustrating the overall process of scheduling appointments for event attendees, according to an embodiment of the invention.

FIG. 8 is a simplified flow diagram illustrating the appointment matching and scheduling process, according to an embodiment of the invention.

FIG. 9 is a block schematic diagram of a machine in the exemplary form of a computer system, according to an embodiment of the invention.

### DETAILED DESCRIPTION

The nature, objectives, and advantages of the invention will become more apparent to those skilled in the art after considering the following detailed description in connection with the accompanying drawings.

The event industry is continuously being driven to produce quantifiable results and present clearer return on investment. In its annual study this year, Meeting Professionals International observes that events will become far more targeted in terms of size, location, content, and attendance. Event organizers have the opportunity to increase the effectiveness of the event for attendees by organizing personalized one-to-one appointments for attendees in which the appointments are effective for conducting business in conjunction with the event.

### Terminology

Event: An event is a gathering of people in a particular place at a particular time for a particular purpose. Examples of events include conferences, conventions, tradeshows, training sessions, users groups, retreats, etc. An Event can also be a virtual or hybrid (physical/virtual) event where the meeting takes place online accessible to attendees on the web or via mobile applications.

Attendee: An attendee is a person who attends an event. Also referred to as an “event participant” or “participant.”

Requesting attendee: The identity of an attendee who has requested a meeting with a matching attendee.

Matching attendee: The identity of an attendee who matches the criteria in appointment preference data associated with a meeting request from the requesting attendee.

Meeting participant: An attendee who is scheduled to participate in a meeting scheduled with at least one other attendee. A requesting attendee and a matching attendee are both meeting participants.

Attendee types: An attendee type is a general classification of attendees for the purposes of administering the event experience. The attendee type may be used to determine the required admission fee (e.g. student, adult, child, buyer, vendor/seller, exhibitor), to establish policy regarding the minimum and maximum number of meetings to be automatically scheduled, the ability to decline a scheduled meeting, the registration form, the criteria for filtering potential individuals for scheduled meetings (e.g. buyer, vendor). Also the attendee type may indicate the role that the attendee will play at the conference (e.g. speaker, exhibitor, staff).

Event producer or organizer: The event producer is responsible for organizing an event including booking the venue, inviting and registering participants, and arranging meetings between individual attendees.

Calendar item: An event comprises a sequence of calendar items for each of the attendees of the event. Each calendar item is associated with a date, time, duration, place, and purpose (topic). Examples of calendar items include agenda items, appointments, and non-participation time. An agenda item is a gathering of attendees that is sponsored as part of the event itself such as a session, exhibits, social receptions, and meals. Appointments include those that are scheduled by the event organizers as well as self-scheduled appointments. Blocked personal time may include time when the attendee will not be participating in conference activities such as arriving late, leaving early, or conducting personal business that is not related to the event.

Appointment: An appointment comprises a time and place for conducting a private meeting between representative attendees of two entities, and each entity may be represented by one or more attendees. An entity may be a company or other organization, or an entity can be a single attendee. An appointment is defined by the list of participants, a start time, an end time, and an appointment location.

Planner-Scheduled Appointment: an appointment that is arranged directly by event organizers on behalf of event attendees.

Self-scheduled Appointment: an appointment that is arranged directly by event attendees, through meeting invitations and responses (of either acceptance or rejection of an invitation).

Template (Appointment Template or Schedule Template): one or more timetables showing all available appointment slots across all days for one or more days of an event. An organizer might create more than one template for the same day, with different lunch times, to reduce bottleneck in the lunch lines.

Schedule: A schedule is the sequence of calendar items for a particular one or more set of attendees.

Matching: The process determining an identity of one or more matching attendees to schedule as (a) meeting participant(s) that satisfy a meeting request by evaluating criteria specified in the associated appointment preference data.

Scheduling: The process of selecting an appointment time and location for a meeting between (among) identified meeting participants.

### Overview

An appointment management tool may enable automatic scheduling of appointments for personal interactions between all types of event participants including general attendees, exhibitors, speakers, etc., at an event. The appointment management capability provides event organizers with tools to facilitate sales, networking, and education among other activities as well as to provide opportunities for making personal connections that were not previously possible. As appointment participants, event attendees benefit from focused interactions that serve mutual objectives, and ultimately get more value out of the time spent at an event.

The appointment management tool allows attendees to specify criteria for selecting another attendee with whom to meet in a planner-scheduled appointment. The criteria may comprise a set of filters to apply to information supplied at registration time. After registration, an attendee may interact with a tool for specifying appointment criteria.

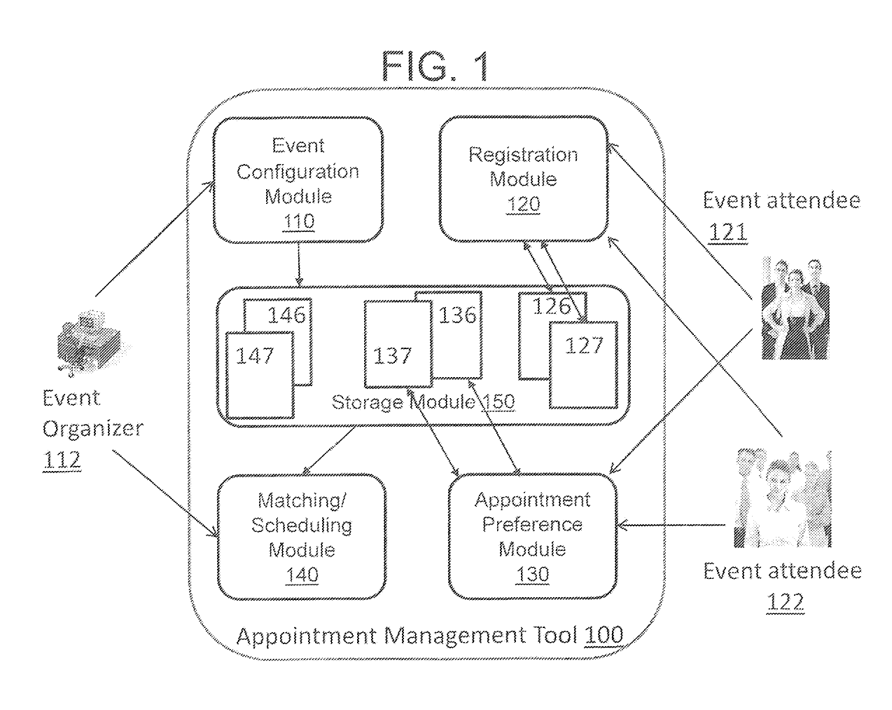

FIG. 1 is a simplified block diagram illustrating the components and use of an Appointment Management Tool 100. The appointment management tool comprises an Event Configuration Module 110, a Registration Module 120, an Appointment Preference Module 130, a Matching/Scheduling Module 140, and a Storage Module 150.

Event Organizer 112 interacts with the Event Configuration Module 110 to configure forms and schedules that are specific to different attendee types and customized for a particular event. The forms include registration forms (126, 127), appointment preference forms (136, 137) and at least one scheduling template (146, 147). Once configured, these forms are stored in Storage Module 150.

The registration module 120 and appointment preference module 130 are configured to take as input a form that is configured by the Event Configuration Module 110 and to generate an online user interface that attendees use for providing information to the system for appointment matching/scheduling. Although attendees enter data through the user interface, it is simpler to refer to this process as “entering data into the form” or “completing the form” even though, technically, the form is just a template for the look, feel, and behavior of the corresponding user interface.

An attendee of a first type 121 (e.g. a buyer) may use an interface provided by registration module 120 to register to attend the event, which includes entering information into registration form 126, and an attendee of a second type 122 (e.g. a seller) may use an interface provided by the registration module 120 to register to attend the event, which includes entering information into registration form 127. The registration module retrieves the configured registration forms from storage, and stores the entered information for later retrieval.

After registration, the attendee of the first type may use appointment preference module 130 to specify criteria for desired appointments using form 136, and the attendee of the second type may use appointment preference module 130 to specify criteria for desired appointments using form 137. The appointment preference module retrieves the configured appointment preference forms from storage and stores each attendee's preferences in the storage module for later retrieval.

The attendee can specify criteria at varying levels of granularity. For example, the attendee may specify that they want to meet with an attendee conducting research on a particular topic, and the tool will identify and select such individuals. Another example is that the attendee may specify to meet with a sales representative from a particular company about a particular product, and the tool may identify individuals that meet the criteria and select one with whom to schedule the appointment. Alternatively, the attendee can use the tool to search for individuals that meet the specified criteria, and the attendee can select one or more individuals with whom to request meetings. The attendee may also rank the meeting requests in priority order and assign each request a relative priority.

After registration closes, event organizer 112 may use the scheduling module that retrieves data input from the registration process through forms 126 and 127, the data input through the appointment preferences process through forms 136 and 137, and the scheduling template(s) to generate appointments that meet the criteria of the participants.

The following example is provided for illustration purposes, without limiting the scope of how the tool may be used. A buyer program, regardless of scale, is an event that brings together a buyer and a seller (alternately referred to as vendor, supplier, or exhibitor) who are mutually interested in exploring a business opportunity with each other. A hosted buyer program is one in which the sellers pay to participate in the event, and the fees are used to attract buyers by offering free admission and possibly even pay for travel and accommodation expenses. In exchange, the buyers agree to attend a certain number of appointments with sellers.

The appointment management tool may receive appointment criteria from both buyers and sellers, then automatically schedule appointments between a buyer and a seller where the seller meets the buyer's criteria and/or the buyer meets the seller's criteria.

The clear return on investment of time and money to buyers and sellers is leading its widespread adoption in the events industry. In the most common case, a buyer intends to procure services that the vendor/supplier/exhibitor is offering. In return, the seller views the buyer as a good sales lead. The key to a successful buyer program is in arranging high-quality appointments where both parties have a strong mutual interest in meeting with each other, while allocating a sufficient number of appointments to minimize downtime at an event. Thus to be useful, a tool providing automatic appointment matching/scheduling capability must be able to schedule a large volume of appointments (i.e. large quantity on the order of tens of thousands for a large conference), the scheduled appointments should match mutually interested parties (i.e. high quality), and it is critical that the appointment preference selection interface be easy to use.

In addition, it is advantageous for an appointment management tool to support self-directed appointments that places the control of who-to-meet and when-to-meet firmly in the hands of event attendees. The freedom of inviting other attendees for a meeting broadens appointment management, and allows attendees to network with each other, interact with speakers, discuss business opportunities with exhibitors.

### Generating Appointments

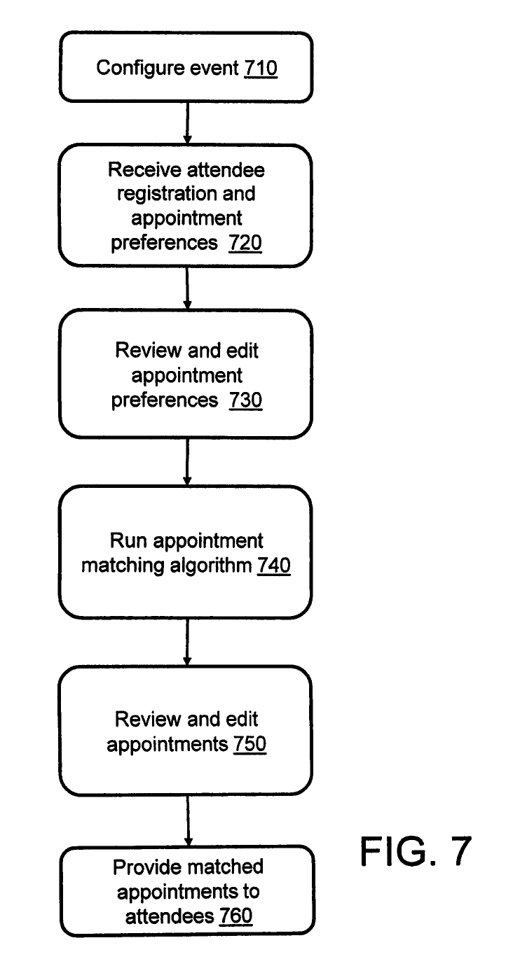

Generating high quality appointments may comprise the following steps illustrated in FIG. 7. In Step 710, the event organizer 112 configures the event by creating a template of appointment time slots, meeting location availability, and customizing registration and appointment preference forms that will be filled out by attendees. One or more schedule templates are created for the event, and each template contains available appointment times. A template is defined by a series of one or more appointment blocks spanning one or more days. In an embodiment, an appointment time block may be a fixed amount of time. For example, creating an appointment block from 9 am to 12 pm, with an appointment duration of 30 minutes may result in 6 appointment slots on the schedule template that are available for the appointment matching/scheduling engine to fill. In an embodiment, discrete appointment time blocks are allocated in the schedule templates, but one appointment time block may have a different duration than another time block. For example, an appointment time block coinciding with a session break may be shorter than an appointment time block coinciding with a speaker session. An appointment block allows for the configuration of time allocated for travel between appointments, if needed. This may be necessitated, for example, if an attendee has appointments with an exhibitor in an exhibit hall or a trade floor and requires some time to walk from one exhibitor booth or location to another.

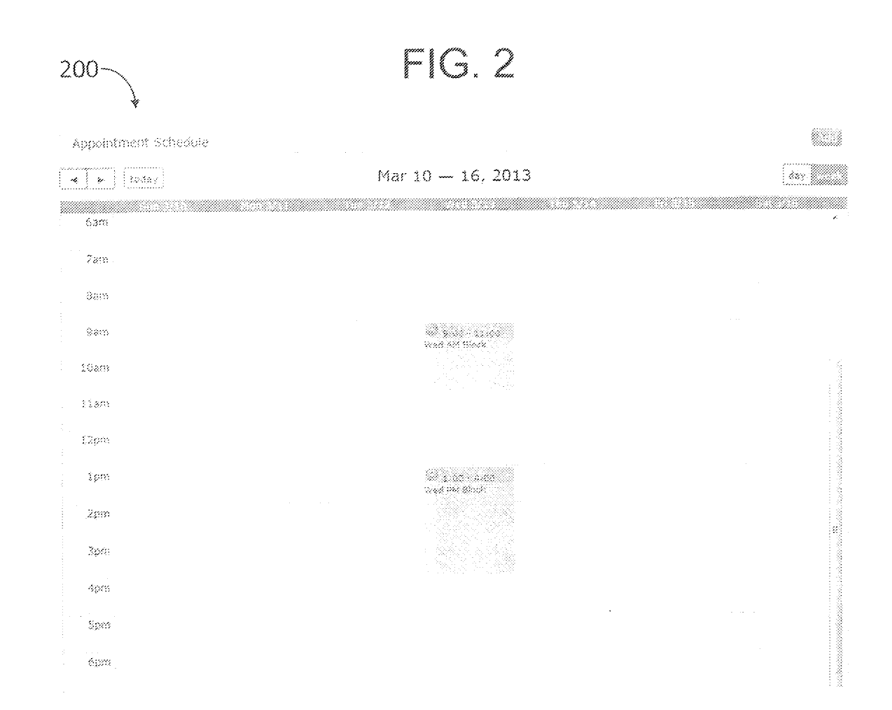

FIG. 2 illustrates an example schedule template 200 according to an embodiment of the invention. The example template specifies appointment time slots for Mar. 10-16, 2013. The example shows two blocks of appointments. One such block is named “Wed. AM Block” that specifies time slots from 9:00-11:00 am on Wednesday, March 13. The other block is named “Wed. PM Block” that specifies time slots from 1:00-4:00 pm on Wednesday, March 13. When the start time or end time of a block or the duration of each appointment scheduled within a block needs to be changed, the name of the block may be used by the event organizer 112 to specify which block to edit. Selecting a block as seen in FIG. 2 may open the details of the block to display details of the block that may include the duration of each appointment within the block or location information associated with time slots within the time block. Each block may have a different duration associated with the meetings scheduled within the block. For example, the meetings scheduled on Wednesday morning may last a half hour each, but the meetings schedule on Wednesday afternoon might last for 1 hour each.

An event organizer might create two templates for the same day, with different lunch times, to reduce bottleneck in the lunch lines. In an embodiment, each template may be stored in a separate table (appointment schedule). In an alternate embodiment, multiple overlapping appointment blocks may co-exist within the same table. For example, a second block may be added to the schedule shown in FIG. 2 from 9:00-noon on Wednesday morning and allocate appointments that last 20 minutes. However, in an embodiment, all the appointments from overlapping blocks may start at the same time. For example, if a conference has parallel tracks, there may be a schedule template for each track. Synchronizing appointment blocks across templates (or overlapping blocks within a template) allows attendees on different tracks to meet with each other.

Meeting location information may come from a variety of sources. For an event featuring exhibits large enough to accommodate meeting space, meetings with an exhibitor may be scheduled in the exhibit hall. Each event facility has its own set of meeting spaces that are entered or loaded into the appointment management tool. In an embodiment, each time block in the schedule may be associated with a particular meeting location. In an alternate embodiment, the meeting spaces at the event may be uploaded independent from the schedule templates and serve as a pool of meeting spaces from which to assign a particular appointment at the time an appointment is scheduled.

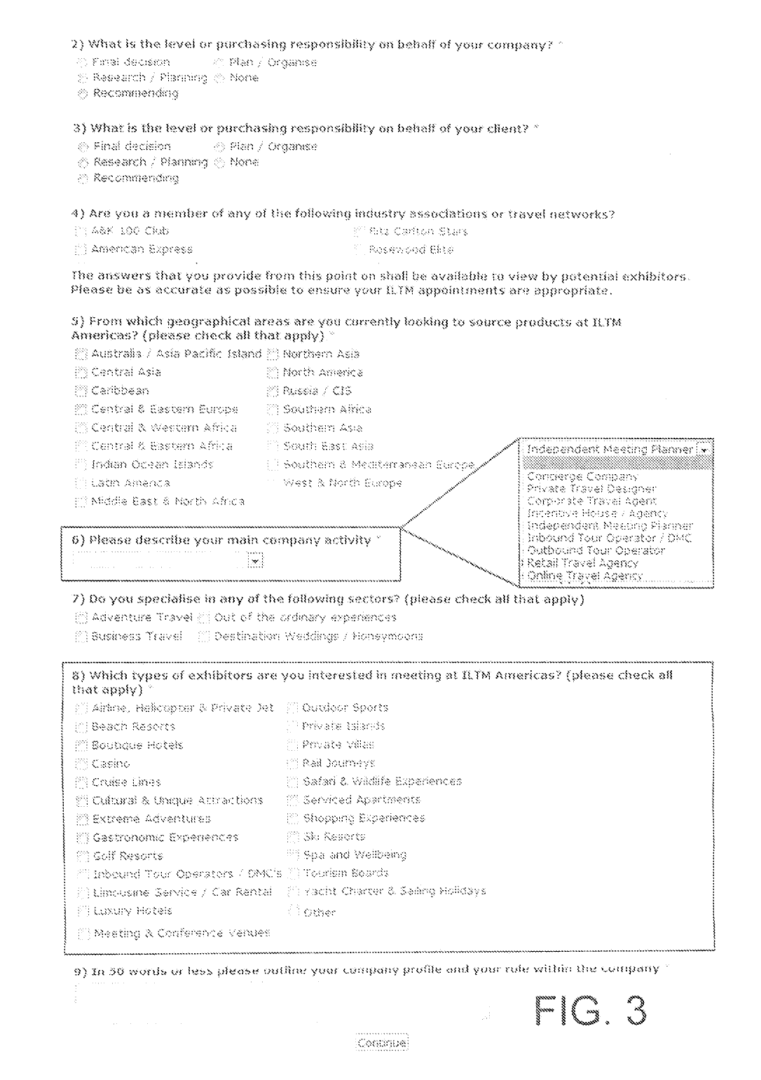

Event organizer 112 may also configure the forms that each type of attendee uses for registration. A registration form used by one attendee type may be different than the registration form used by an attendee of a different type, because the information collected about an attendee may be different based on attendee type. For example, different kinds of information may be collected from a buyer than a seller. FIG. 3 shows a portion of an example registration form for a buyer. Information relevant to a buyer may include questions such as level or purchasing responsibility, from which location products will be acquired, or interest in which types of exhibitors. In contrast, a sellers' registration form may solicit information on dollars of sales (buyers may use as an indication of company stability and success) or information about the types of products or services for sale. The information specified in the registration form of one attendee may be used by another attendee to express preferences for appointments. For example, a buyer who responds to question 2 by indicating that the buyer has no purchasing responsibility (none) may not be granted an appointment with a seller who prefers to meet only with buyers having the final decision.

In addition, the event organizer 112 may configure appointment preference forms that encode the policies regarding the preferences that each type of event attendee may request. Policies may be configured regarding constraints on appointment preferences that are reflected in and/or enforced by the form. These constraints can affect the balance between the effectiveness of the automatic appointment matching/scheduling tool and the perceived value of the schedule appointments to attendees. An example of an event policy regarding appointment scheduling is that all registered attendees may access the form. Another event policy may be that attendees must be pre-qualified for participating in appointment scheduling, and only pre-qualified attendees may access the form.

There are at least three different kinds of appointments that are automatically scheduled by the scheduling/matching algorithm. The highest priority appointment type is one in which both parties to the appointment have expressed preferences to meet with each other. In other words, the desire to meet is mutual. A second appointment type is one in which the preferences are not mutual. In an embodiment, preferences specified by one type of attendee may be assigned higher priority than preferences specified by a different type of attendee. For example, a buyer's preference may be considered higher priority than a seller's preference or vice versa. In a system where unequal priority is assigned to non-mutual attendee preferences, the second appointment type may be one in which an attendee whose preferences have higher priority has requested to meet with an attendee whose preferences have lower priority.

For example, if buyer appointment preferences are given higher priority than seller appointment preferences, then an appointment preference requested by a buyer to meet with a certain seller may be classified as the second appointment type if the certain seller has not requested to meet with the buyer. However, if priorities assigned to appointment preferences are the same for all attendee types, then all non-mutual appointment preferences may be classified as the second appointment type. A third appointment type is a non-mutual appointment preference in which an attendee with lower priority appointment preferences requests to meet with an attendee having higher priority appointment preferences.

All three types of appointments may be scheduled during automatic appointment matching/scheduling. As a result, an appointment can be scheduled for an attendee, for which there is no corresponding preference. In addition, not all meeting requests may result in a scheduled appointment. For example, if too many attendees want to meet with the same other attendee, some attendees may not have all their meeting requests fulfilled. Thus, some requests may not result in a scheduled appointment. Therefore, the number of meeting requests and the number of scheduled appointments may be different.

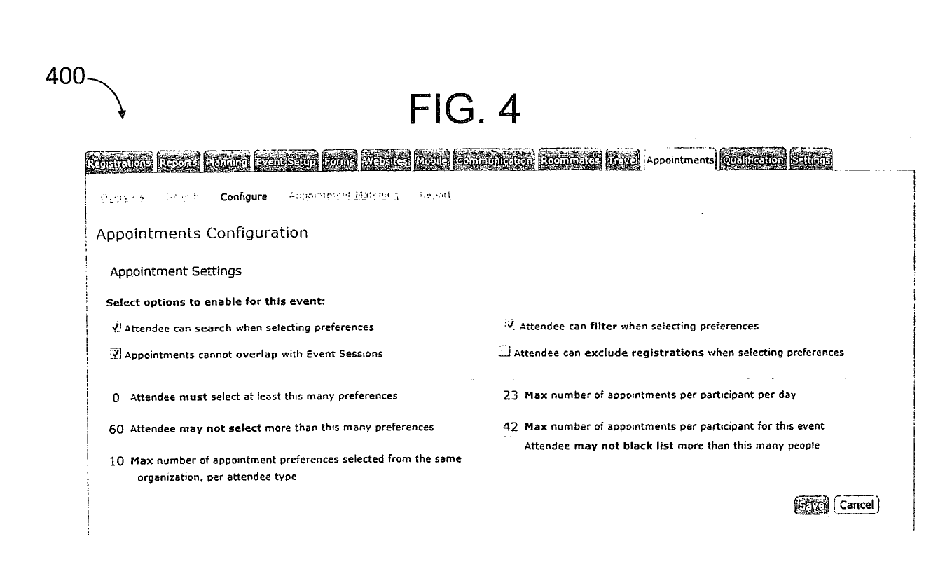

FIG. 4 is an example screen shot showing a portion of the configuration process for an appointment preference form. The appointment configuration 400 shown in FIG. 4 specifies that each participant is not required to express any appointment preferences but may express no more than 60. The maximum number of appointments that may be scheduled for each attendee for each day is 23 and the maximum number of appointments that may be scheduled for an attendee for the entire event is 42. In addition, the event organizer can configure to limit the number of preferences that any attendee can make with another attendee representing the same organization. For example, there may be multiple attendees from organization XYZ attending the event. According to the configuration shown in FIG. 4, each attendee may only request to meet with ten attendees of the same attendee type from organization XYZ. In an embodiment, limiting the number of preferences that can be requested may be enforced by the appointment preferences interface form. In another embodiment, the appointment matching/scheduling algorithm may also limit the number of appointments scheduled between an attendee and representatives from the same company.

Though not shown in FIG. 4, other portions of configuration for the appointment preference form may include which attendee types are allowed to participate in appointments and also which attendee types may be matched to meet with other attendee types.

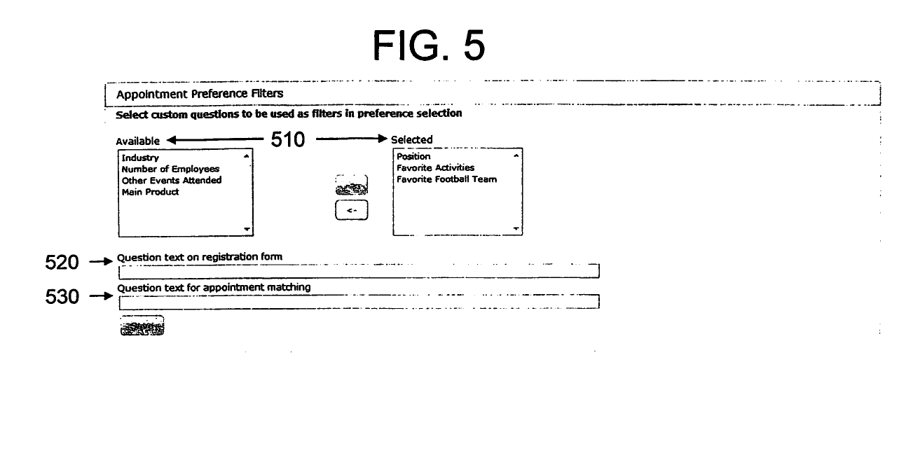

FIG. 5 is a screen shot illustrating another portion of the configuration process for configuring an appointment preference form according to an embodiment of the invention. The filters shown in the “Available” and “Selected” lists (510) are a combination of standard filters that are available for every event and custom filters that are defined specifically for the event being configured. A standard filter compares data entered into a standard portion of the registration form against a desired response. In an embodiment, “industry” may be a standard filter that allows an appointment preference to be specified based on the name of the industry provided by an attendee at registration time. In an embodiment, “Favorite Football Team” may be the name associated with a custom question that only attendees of the current event can use for specifying appointment preferences. The text box labeled, “Question text on the registration form” 520 allows the event organizer to enter a custom question to appear on the registration form, such as “What is your favorite football team?” The text box labeled, “Text box for appointment matching” allows the event planner to assign a name for the filter associated with the custom question provided in 520. The name, such as “Favorite Football Team” appears in the list of available filters in the lists 510. The name of the filter may be expected to convey to an attendee filling out an appointment preference form the kinds of responses to the associated question. For example, an attendee may expect that the name of a football team is provided on the registration form, a preference may be requested to meet only with those individuals who specify the name of a particular team.

The event organizer can select from the list of available filters to make available on the appointment preference form. An attendee preference form configured as shown in the example of FIG. 5 may allow an attendee to specify an appointment filter based on position, favorite activities, and/or favorite football team.

In addition to establishing event policy that is reflected in the configuration of the forms used by attendees, the event organizer may also specify user interface configuration that affects the look, feel, and operation of the forms. For example, the following are examples of user interface attributes that may be specified:
Whether or not to allow attendees to view their selections and solicit confirmation of their profile details again.
The form may be configured with the attendee types that are relevant for this event. For example, an event might have attendee roles of (e.g. buyer, seller), (student, instructor), (employee, manager), (university researcher, corporate researcher), etc.
Whether or not to enable “Preference Search” and “Preference Filtering” for the previously configured appointment preferences form. This choice may depend on how many conference attendees are expected to register and whether searching or filtering are both needed. For a large conference, providing both a “preference search” and a “preference filter” may be helpful. A preference search may allow an attendee to describe desirable attributes of those they would like to meet and the preference filter may help eliminate from consideration those attendees who are not of interest.
Whether or not to allow an explicit blacklist or exclusion list of other attendees with whom a potential matching attendee does not wish to meet for whatever reasons.

Returning to the steps of FIG. 7, in Step 720, the attendees interact with the configured registration and appointment preferences forms, and the appointment management tool stores the information provided by the attendees through these forms. In an embodiment, the registration form allows an attendee to specify which event sessions they intend to attend so that their appointments may be scheduled around these sessions. In an alternate embodiment, an attendee may express event sessions they plan to attend when filling out the appointment preference form. In addition, in an embodiment, an attendee may block out times in their schedule during which they do not want an appointment scheduled.

In an embodiment, meeting requests and appointment preferences may be collected only after the event is scheduled, and preferably after conference registration has taken place so that preferences may consider when event agenda items are scheduled as well as the list of attendees. However, in an embodiment, collecting appointment preferences may occur before event registration begins.

Once the form has been configured and made available, attendees can begin to submit their meeting requests with appointment preferences through the form. Each attendee may be allowed to specify appointments within the limits configured by the event organizer. In an embodiment, the attendee authenticates to the system (e.g. logs in) using information established by the conference registration. Thus, the system can retrieve one or more of the attendee name, role, and organization obtained from information entered during registration. In an alternate embodiment, the attendee may specify their name, role, and organization as an input to the appointment preferences form.

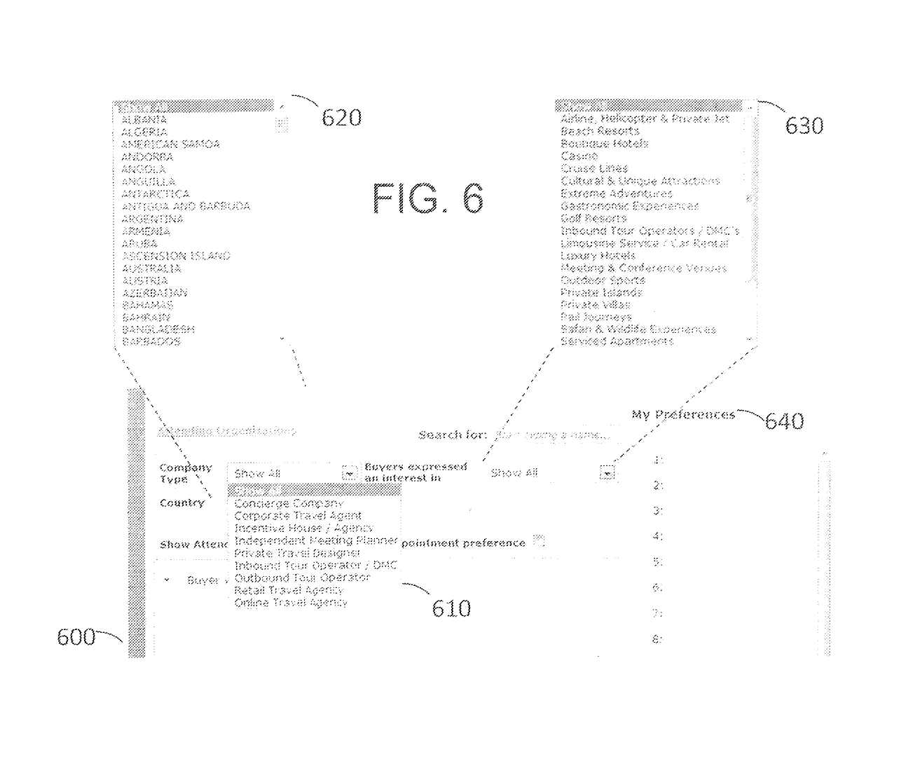

FIG. 6 is a screen shot of an example appointment preferences form 600 with which an attendee may interact to express appointment preferences. Form 600 has been customized for use by a seller. Information that a buyer provides at registration time such as Company Type 620, Country 610, and Interest 630 may be displayed for selection when a seller creates an appointment preference. For example, a seller might only want to meet with buyers who are Independent Meeting Planners in the United States who are interested in Beach Resorts. In an embodiment, all sellers matching the criteria may be displayed for the seller, and individuals selected for placement under My Preferences 640.

For each appointment preference, an attendee may identify the name of the person with whom the attendee would like to meet. In an embodiment, the names of attendees may be filtered by specifying the name of the organization they represent. For example, an attendee may want to meet with a representative of XYZ Corporation, and the names of attendees representing XYZ Corporation may be displayed for selection. Alternatively, the corporation name may be specified without the requesting attendee subsequently choosing a name, and the appointment matching system may select an appropriate person for the appointment.

Appointment preferences direct the appointment matching algorithm to select one or more matching attendees with whom to meet. The meeting request may either identify an individual or group with whom to meet or be associated with criteria for selecting an individual or group with whom to meet. However, as explained earlier, an attendee may be scheduled to meet with another attendee based on the other attendee's request to meet. In an embodiment, an attendee may specify to deny meetings from being scheduled in response to a meeting request from an attendee with specified attributes. For example, a 49ers football fan may direct the appointment matching algorithm not to schedule an appointment with anyone who is a self-described Raiders fan.

Once all of an attendees meeting requests have been entered, the requesting attendee assigns a relative priority to each meeting request, and the requesting attendee's meeting requests are ranked in priority order.

In Step 730, the event organizer may review and edit appointment preferences. For example, an event organizer can remove a specific appointment, from a buyer and corresponding seller's calendar or diary, scheduled by the system or device based on specific knowledge about a particular buyer or seller. For example, if the event organizer configures the appointment management tool not to include the ability for attendees to specify criteria of those they do not want to meet, and an event organizer knows that a particular buyer has complained about a seller that would match criteria associated with one of the buyer's meeting requests, the event organizer may edit the appointment preference to prevent an appointment being scheduled between the complaining buyer and undesirable seller. An event organizer can use the appointment management tool to make selective changes to the preferences before scheduling appointments. The tool may allow the event organizer to search for all preferences expressed by an individual attendee and change an existing preference, add another preference, or delete a preference previously entered. One example of the usefulness of this feature is that the tool may allow an event organizer to delete appointment preferences requested by an attendee who cancels their registration before appointment matching/scheduling occurs.

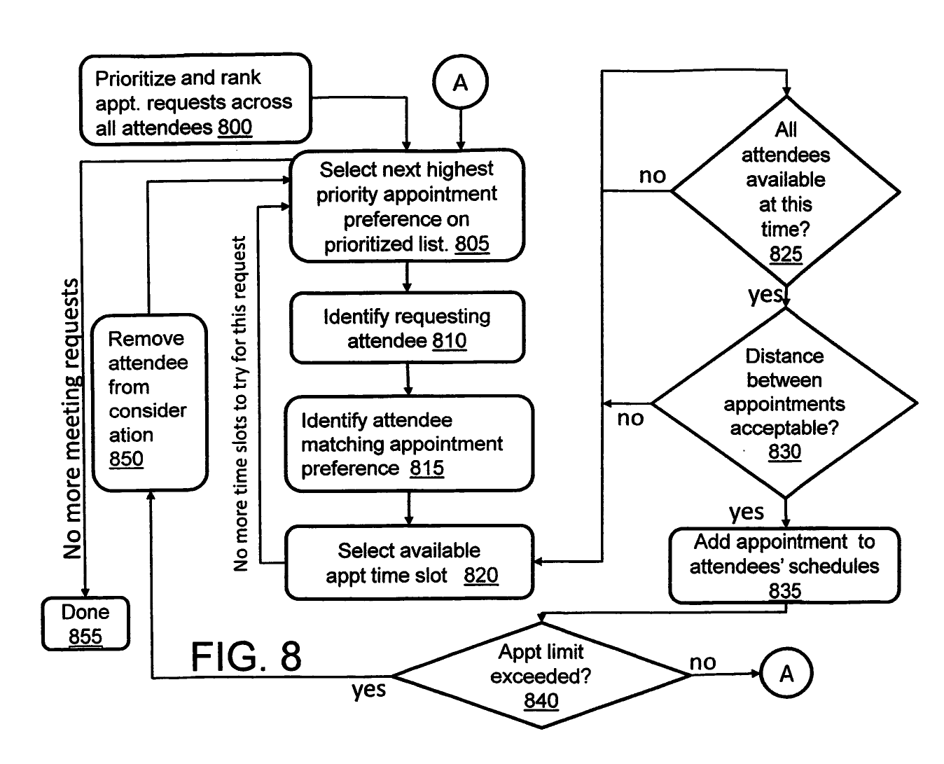

In Step 740, the appointment matching/scheduling algorithm is run to schedule appointments based on template time schedules, meeting locations, and attendee appointment preferences. FIG. 8 is a simplified flow diagram that illustrates the process for scheduling an appointment. In Step 800, each meeting request with appointment preferences expressed by all attendees is assigned a priority by the system and listed in priority order from highest ranking requests to lowest. That is, the meeting request list may include all meeting requests for all attendees. An attendee meeting request and appointment preference has the general structure of “requesting attendee A wants to meet with matching attendee X”, with a ranking specified by requesting attendee A. Alternatively, the appointment preference may express a desire to have an appointment with an attendee meeting criteria Y.

The priority assigned to a meeting request by the matching/scheduling algorithm may be based on a combination of factors. The process for scoring the preferences and assigning a priority may be based at least on the requesting attendee's specified ranking for having an appointment with another attendee. If a subsequent preference is found for attendee X to meet with the attendee A, their mutual preferences may be combined into a single meeting request, and the priority assigned to the request raised. The highest score would be assigned to a mutual meeting request for which both meeting participants specify the highest relative rank for the appointment. Additional attributes can also be brought into consideration for refining the scores further, including weighting for specific attendee types.

Once all the requests are scored, and common preferences are combined, in Step 805, the matching/scheduling engine selects the highest-ranking request remaining in the list and attempts to schedule an appointment satisfying the preferences.

In Step 810, the requesting attendee(s) associated with the request is/are identified. In Step 815, if the request is not a mutual request, a requested attendee is identified either directly by the preference, or the preference criteria is evaluated to identify an attendee that satisfies the criteria. The request is then removed from the meeting request list.

In Step 820, a time slot is selected from the template schedules, and in Step 825, the respective calendar for the requesting attendee and the matched attendee are consulted to verify that this selected time slot is available for both parties to meet. If the time slot is not available for one of the meeting participants, Step 820 is performed again to select a different time slot. Although not explicitly shown in the flow diagram, if the time slot is available for all participants, then the appointment count associated with the day of the appointment for each participant is compared to the daily maximum. If a participant has met the maximum for that day, another time slot may be selected to attempt to schedule the appointment on a different day.

If all participants are authorized and available to meet at the selected time slot, then a location for the meeting is determined. In Step 830, a determination is made as to whether there is an available meeting location that is close enough to the location of agenda items immediately before and after the selected time slot.

In an embodiment, when at least one of the participants in a scheduled appointment is an exhibitor, the meeting may be held at the exhibitor's booth. In an embodiment, each appointment time slot may be associated with a meeting location, ensuring that every appointment has at least one place to meet. In an alternate embodiment, meeting locations are a pooled resource and become associated with specific appointments at scheduling time. Thus, it may be possible for an appointment time slot to go unscheduled for lack of an available location to meet.

Another consideration for scheduling an appointment is the expected location of each meeting participant during adjacent time slots. An appointment should not be scheduled for an attendee at a location that is too far away from where the attendee is scheduled to be just prior to, and just after, the appointment. In an embodiment, each appointment location is associated with an event zone. For example, a first appointment may be located in Zone 4. When scheduling a second appointment immediately after the first appointment, a location for the second appointment may be sought within Zone 4 or in a zone adjacent to Zone 4.

In an embodiment, the appointment scheduling process may also take the attendees' other agenda items into consideration. For example, when the attendee plans to attend an event session in Zone 2, the scheduling process may try to find an appointment location within Zone 2 or adjacent to Zone 2 for an appointment scheduled immediately before or immediately after the session. In Step 830, a check is made to ensure that the location associated with the appointment time slot is close enough for all participants. In an embodiment using a pool of locations, a location may only be selected from the pool if the location is within the configured distance threshold based on the distance from previous and next locations for both parties. Thus, location selection may also be performed at Step 830. The location may be selected at random for association with the selected appointment time slot. If the location associated with the appointment time slot is determined to be too far away, an alternate location may be selected for the same time slot and the distance test may be performed again. If the location is pre-associated with the appointment time slot, a new appointment time slot may be selected if its associated location is not acceptable.

If an acceptable meeting location is found for the selected time slot, then in Step 835, the appointment is added to each participant's calendar at the selected time slot and selected location. If there is no acceptable meeting location, then Step 820 is performed again to select a different time slot. If all available time slots have been ruled out, then no appointment is scheduled for the current meeting request, and in Step 805 another meeting request is taken from the top of the list.

When an appointment is added to a participants' calendar, the total event meeting count for that participant is incremented as well as the daily count for the day on which the appointment will take place. If the incremented total event meeting count reaches the maximum total appointments allowed for the event, then in Step 850, the participant may be removed from consideration and may not be scheduled for any further meetings.

Next, Step 805 is performed again, and the next highest priority meeting request is selected from the list. When the list is empty, then the matching/scheduling algorithm is done (Step 855).

Other variations of the scheduling algorithm may be used. In one embodiment, instead of having a single prioritized meeting request list for all attendees, there may be a separate list for each attendee type. Each list may be processed according to the steps described above; however, meeting requests may be processed from each list in round-robin style. For example, if there is a buyer's list of prioritized requests and a separate sellers' list of prioritized requests, the first meeting request processed may come from the buyers list and the next may come from the seller's list. The meeting request selection process may alternate between the two lists. In an embodiment in which separate lists are maintained, the matching algorithm may only consider matching attendees from a list representing a different attendee type than the type of the requesting attendee. In other words, a policy may be enforced that only appointments between buyers and sellers will be scheduled, and no appointments among sellers or among buyers will be scheduled.

In an alternate embodiment, each individual attendee's prioritized meeting requests may be considered as a separate list, and the scheduling process may attempt to satisfy a meeting request from each attendee before attempting to schedule a second appointment for an attendee. In such an embodiment, mutual meeting requests may not be combined, but when a specific individual is specified for whom the request is mutual, the corresponding meeting request may also be removed from the list of the matched attendee. When criteria is specified rather than the identity of an individual, priority may be given for matching individuals who have expressed a desire to meet with the requesting attendee or specified criteria that matches the requesting attendee.

In Step 750, after the appointment scheduling process has been performed, the event organizer may interact with the appointment management tool to change attributes of individual appointments or a group of related appointments. In an embodiment, the event planner may cancel all appointments scheduled with an attendee who cancels their plans to attend the event, freeing up timeslots in the schedules of the other meeting participant. Another example when this feature may be useful is that an event agenda item might need to be re-scheduled to a new time because a speaker's availability changes, and those intending to attend the re-scheduled session may need to have conflicting appointments rescheduled. In an embodiment, the event organizer may manually change an attribute of an individual appointment or group of appointments. In an embodiment, appointment changes may be made by changing the inputs to the appointment scheduling process, such as the appointment template or an attendee's schedule, and the appointment scheduling process may be re-run.

In Step 760, the appointments for each attendee are combined with the conference event schedule to create a unified custom schedule for the attendee. In an embodiment, the unified schedule may only show the sessions that the attendee has elected to attend together with their blocked out time and scheduled appointments. In an alternate embodiment, the unified custom schedule may include the entire event schedule together with the attendee's scheduled appointments.

The appointment schedules may be delivered electronically such as through email, fax, or retrievable through an event website (e.g. My Agenda web page), a mobile application, or a hard copy of the schedule may be printed and mailed to the attendee before the conference and/or handed to the attendee at the event registration table. The schedule may be attached to an email message in the form of an attachment schedule such as .ics attachment for importing the schedule into Outlook or Google Calendar.

In addition to the automatic scheduling of appointments described above, the appointment management tool may also support self-directed appointment scheduling in which an attendee may send a meeting request directly to one or more other attendees, with functionality similar to meeting requests in Microsoft Outlook. However, instead of scheduling the appointment into their personal email calendar, the appointment may appear in their MyAgenda calendar provided by the event.

In an embodiment, a self-directed or self-scheduled appointment may be requested without divulging contact information for the requested party. The system may act as an intermediary and carry the meeting request message to the requested party and allow the requested party the opportunity to accept or deny the request. In contrast, other tools providing meeting request capabilities require sending the meeting request to the email address of the requested party, which means the requester must know the email ID of the party with whom an appointment is requested.

### An Example Machine Overview

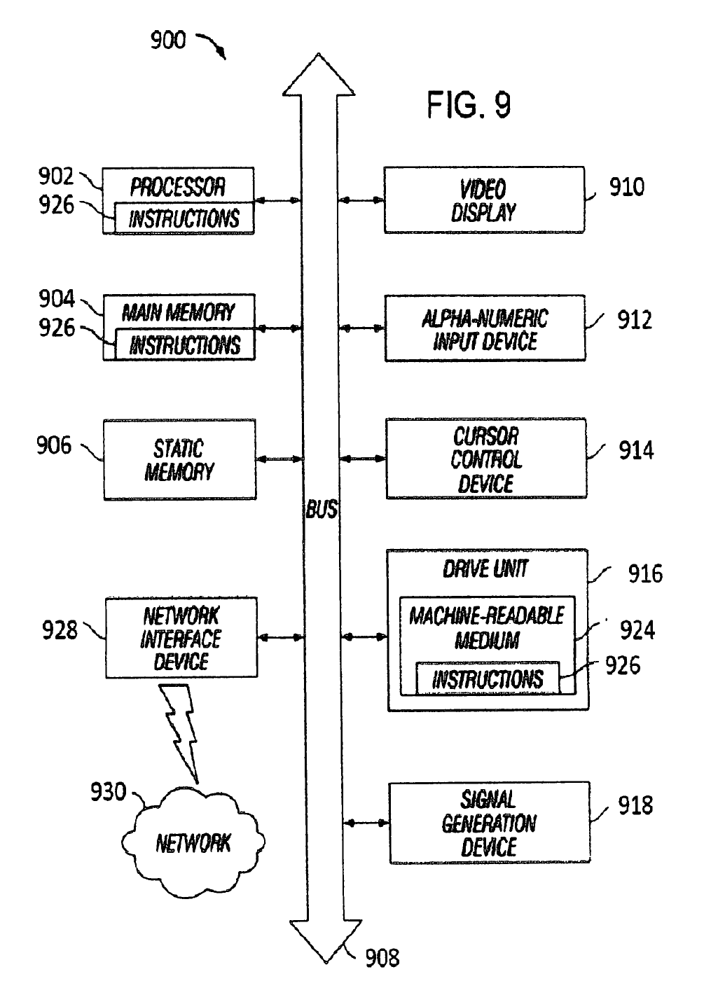

FIG. 9 is a block schematic diagram of a machine in the exemplary form of a computer system 900 within which a set of instructions may be programmed to cause the machine to execute the logic steps of the invention. In alternative embodiments, the machine may comprise a network router, a network switch, a network bridge, personal digital assistant (PDA), a cellular telephone, a Web appliance or any machine capable of executing a sequence of instructions that specify actions to be taken by that machine.

The computer system 900 includes a processor 902, a main memory 904 and a static memory 906, which communicate with each other via a bus 908. The computer system 900 may further include a display unit 910, for example, a liquid crystal display (LCD) or a cathode ray tube (CRT). The computer system 900 also includes an alphanumeric input device 912, for example, a keyboard; a cursor control device 914, for example, a mouse; a disk drive unit 916, a signal generation device 918, for example, a speaker, and a network interface device 928.

The disk drive unit 916 includes a machine-readable medium 924 on which is stored a set of executable instructions, i.e. software, 926 embodying any one, or all, of the methodologies described herein below. The software 926 is also shown to reside, completely or at least partially, within the main memory 904 and/or within the processor 902. The software 926 may further be transmitted or received over a network 930 by means of a network interface device 928.

In contrast to the system 900 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

### Other Embodiments

Although the use of the appointment management tool is explained using the example of an event that bring buyers and sellers together, the tool may be useful for many different kinds of events with different types of attendees. For example, the tool could be used to schedule appointments between researchers and/or developers attending a technical conference who are independently working to solve similar problems. The appointments which may resemble a birds of a feature session may address much narrower and specific topics of interest to individual attendees.

Another example may be scheduling appointments between users and company representatives at a user group meeting for getting individual questions answered or for exchanging information and opinions about the future of the product. In addition, rather than limiting the scheduling of appointments for individual attendees, the tool may allow attendees to form groups and the meetings may be scheduled between two groups of attendees.

The appointment management tool may also be used for automated appointment matching and scheduling in the context of a virtual or hybrid (physical/virtual) event. People attending a set of presentations online may be matched for one-on-one meetings that may take place over the telephone, video teleconferencing, or other electronic media. In the context of a pure virtual event, the location of the meeting may not be a factor for scheduling the meeting. An example of a hybrid event may be an online class with participants from all over the country, but each student may be assigned to a study group with other students living in the same general area.

The appointment management tool may also be used for appointment matching and scheduling independent of any event. For example, the tool may be used for matching patients and doctors. A doctor may express preferences that filter the kinds of patients the doctor will accept and a patient may express a preference for a doctor of a particular specialty in a particular location who has an appointment available the same afternoon. Although matching tools may exist for identifying physicians based on certain criteria, existing tools are not integrated with a scheduling mechanism such that the schedule of the doctor and patient both may be considered as criteria in matching a patient to an available doctor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Furthermore, although elements of the invention may be described or claimed in the singular, reference to an element in the singular is not intended to mean “one and only one” unless explicitly so stated, but shall mean “one or more”. Additionally, ordinarily skilled artisans will recognize that operational sequences must be set forth in some specific order for the purpose of explanation and claiming, but the present invention contemplates various changes beyond such specific order.

1. An apparatus for scheduling appointments among attendees at an event comprising:
a computing device having a processor coupled to a memory and a storage device, the processor configured to:
present a configuration interface to an event organizer for obtaining configuration data for configuring the appointment scheduling apparatus for the event that is attended by one or more attendee types;
generate, based on the configuration data, a first registration form and corresponding interface for a first attendee type and a second registration form and corresponding interface for a second attendee type;
generate, based on the configuration data, an appointment preferences form and corresponding interface for obtaining meeting requests with appointment preferences data for each attendee of the event;
present the first registration interface to a first attendee of the first attendee type and obtain first registration data from the first attendee;
present the second registration interface to a second attendee of the second attendee type and obtain second registration data from the second attendee;
present the appointment preferences interface to and obtain first appointment preferences data for a first meeting request from the first attendee;
present the appointment preferences interface to and obtain second appointment preferences data for a second meeting request from the second attendee;
for each attendee of the first attendee type, scheduling appointments with one or more attendees of the second attendee type;
wherein scheduling an appointment between said each attendee of the first attendee type and a particular attendee of the second attendee type is performed using the configuration data, the registration data provided by the particular attendee, and the appointment preferences data provided by said each attendee of the first attendee type;
for each scheduled appointment, provide the scheduled appointments to attendees participating in said each scheduled appointment.

2. The apparatus of claim 1, wherein the configuration data comprises:
a maximum number of appointments to schedule for each attendee per day;
a minimum number of appointments to schedule for each attendee for the entire event; and
a minimum number and a maximum number of meeting requests that each attendee may specify.

3. The apparatus of claim 1, wherein the configuration data comprises for each attendee type, a list of questions for obtaining registration data for an attendee of said each attendee type;
wherein first registration data obtained through the first registration interface answers one or more questions of the list of questions presented in the first registration interface; and
wherein second registration data obtained through the second registration interface answers one or more questions of the list of questions presented in the second registration interface.

4. The apparatus of claim 1, wherein the first appointment preferences data is used to create a filter that is applied to answers to the list of questions obtained from the second attendee through the second registration interface.

5. The apparatus of claim 1, wherein the one or more attendee types comprise a plurality of attendee types;
wherein the list of questions on the first attendee registration form is different from the list of questions on the second attendee registration form; and the first attendee type is different from the second attendee type.

6. The apparatus of claim 5, wherein the first attendee type is a buyer, and the second attendee type is a seller.

7. The apparatus of claim 5 wherein the first attendee type is a user of a particular product, and the second attendee type is a representative of the company that sells the particular product.

8. The apparatus of claim 5, wherein the configuration data further comprises a specification of pairs of attendee types for which the appointment scheduling apparatus will schedule appointments.

9. The apparatus of claim 5, further comprising:
for each attendee of the second attendee type, scheduling appointments with one or more attendees of the first attendee type using the configuration data, the first registration data and the second appointment preferences data.

10. The apparatus of claim 1, wherein there is only one attendee type; and
wherein the first registration interface is the same as the second registration interface, and the first attendee type is the same as the second attendee type.

11. The apparatus of claim 1, further comprising an appointment preferences editing interface for changing appointment preference data.

12. The apparatus of claim 1, further comprising a scheduled appointments editing interface for changing scheduled appointments.

13. A method for scheduling a plurality of appointments among attendees of an event, the method comprising:
receiving first registration data from a first attendee of a first attendee type and second registration data from a second attendee of a second attendee type;
receiving first appointment preferences data from the first attendee and second appointment preferences data from the second attendee;
a processor selecting the second attendee as a suitable match for a meeting requested by the first attendee based on the second appointment preferences data; and
a processor scheduling an appointment between the first attendee and the second attendee;
wherein the processor determines when and where the first and second attendees will meet.

14. The method of claim 13, wherein scheduling the plurality of appointments further comprises:
assigning a score to each meeting request of the union of all meeting requests for all attendees;
creating one or more lists of scored meeting requests, each list of the one or more lists sorted in rank order based on the assigned score for each meeting request in said each list;
selecting a meeting request with the highest score from one of the one or more lists of meeting requests;
identifying the requesting attendee of the meeting request;
identifying a matching attendee that matches the selected appointment preference data associated with the meeting request;
selecting an appointment time slot;
determining that both the requesting attendee and the matching attendee are available during the selected appointment time slot;
selecting a location for an appointment during the selected appointment time slot;
determining whether a first distance, a second distance, a third distance, and a fourth distance are all below a threshold distance, wherein:
the first distance is the distance between the selected location and a scheduled location of the requesting attendee immediately before the selected appointment time slot;
the second distance is the distance between the selected location and a scheduled location of the requesting attendee immediately after the selected appointment time slot;
the third distance is the distance between the selected location and a scheduled location of the matching attendee immediately before the selected appointment time slot; and
the fourth distance is the distance between the selected location and a scheduled location of the matching attendee immediately after the selected appointment time slot; and
responsive to determining that the first distance, the second distance, the third distance, and the fourth distance are all below a threshold distance, adding the appointment to the requesting attendee's calendar and the matching attendee's calendar at the selected appointment time slot at the selected location.

15. The method of claim 14, wherein the one or more lists of scored meeting requests comprises a single list including meeting requests for all attendees.

16. The method of claim 14, wherein the one or more lists of scored meeting requests comprises a plurality of list of scored meeting requests comprising a separate list for each attendee type;
wherein a first list of scored appointments includes meeting requests only for attendees of a first attendee type; and
wherein a second list of scored meeting requests includes meeting requests only for attendees of a second attendee type that is different from the first attendee type.

17. The method of claim 16, wherein meeting requests are selected from the plurality of lists in a round robin;
wherein subsequent to adding an appointment to the respective calendars of the requesting attendee and the matching attendee, selecting a next meeting request from a second list;
wherein the added appointment satisfies the meeting request selected from a first list that is different from the second list.

18. The method of claim 16, wherein the one or more lists of scored meeting requests comprises a separate list for each attendee; and
wherein subsequent to adding an appointment to the respective calendars of a first requesting attendee and the matching attendee, selecting a next meeting request from a second requesting attendee who is different from the first requesting attendee.

19. The method of claim 14, further comprising:
determining that a maximum number of appointments have been scheduled for the requesting attendee; and
removing the requesting attendee from the set of attendees waiting for appointments.

20. The method of claim 14, further comprising:
selecting a different appointment time slot responsive to:
determining that the requesting attendee or the matching attendee are not available during the selected appointment time slot; or
determining that there is no available location to select such that the first distance, the second distance, the third distance, and the fourth distance are all below the threshold distance.

21. The method of claim 14, wherein assigning a score to each meeting request comprises:
determining whether said each meeting request is a mutual meeting request, wherein a mutual meeting request is one for which there is a matching attendee that matches appointment preference data associated with said each meeting request; and
the matching attendee has expressed a particular meeting request for which the requesting attendee matches appointment preference data associated with said particular meeting request.

22. The method of claim 14, wherein assigning a score to each meeting request is based on the relative priority assigned to said each appointment by the requesting attendee.
